(19) United States
(12) Patent Application Publication
(10) Pub. No.: US 2012/0111693 A1
(43) Pub. Date: May 10, 2012

(54) Method of Manufacturing a Transmission Clutch Assembly with Reduced Squawk

(75) Inventors: Jim Chern, Troy, MI (US); Carl Garbacik, Northville, MI (US); Robert J. Miller, Livonia, MI (US); Jau-Wen Tseng, Ann Arbor, MI (US)

(73) Assignee: Ford Global Technologies LLC

(21) Appl. No.: 13/351,447

(22) Filed: Jan. 17, 2012

Related U.S. Application Data
(63) Continuation-in-part of application No. 12/417,603, filed on Apr. 2, 2009.
Application No. 12/417,603 is a continuation-in-part of application No. 13/351,437, filed on Jan. 17, 2012.

(51) Int. Cl. F16F 15/10; B23P 11/00

(52) U.S. Cl. 192/30 V; 29/428

(57) ABSTRACT

The present disclosure relates to a method of manufacturing a transmission clutch assembly configured to reduce squawk during engagement, the method including: forming a clutch component; and coupling a plurality of mass dampers to the clutch component to split a mode of vibration for the clutch component during engagement.

### CROSS-REFERENCE TO RELATED APPLICATIONS

This application is a continuation-in-part and claims the benefit of U.S. Non-Provisional application Ser. No. 12/417,603 titled “Vehicle Braking Assembly” filed Apr. 02, 2009, and U.S. Non-Provisional application Ser. No. 13/351,437 titled “Transmission Clutch Assemblies with Squawk Reduction Techniques” filed Jan. 17, 2012, both of which are hereby incorporated by reference in their entirety.

### TECHNICAL FIELD

The present disclosure relates to squawk (or noise) reduction in vehicle transmission clutch assemblies.

### BACKGROUND

Modern transmissions include clutch assemblies to control the relative speed of the vehicle wheels relative to engine speed. These clutch assemblies include rotating parts that alternate between engaged and disengaged positions. During clutch engagement clutch parts can vibrate with respect to the main transmission shaft. Such vibration can cause unwanted noise that is commonly referred to as “squawk.” Many existing transmissions seek to reduce squawk by improving transmission lubrication or using electromechanical shift control (or e-shift). It is more effective however to add mass to one or more components of the clutch assembly in order to alter the clutch assembly mode of vibration during engagement.

There is a U.S. Pat. No. 7,163,095 titled “Clutch Assembly with Vibration Damper” that discloses the use of a damper ring that couples to a friction surface on a clutch hub to reduce self-excitation of the clutch assembly. This arrangement, however, is less efficient than the teachings in the current disclosure because it requires mass be added around an entire circumference of the clutch hub; and the connection between the clutch hub and damper ring requires friction coupling which also results in unneeded energy loss during engagement.

Accordingly, it is desirable to have a more efficient manner of reducing squawk in the vehicle transmission. As disclosed herein, it would be beneficial to use other types of mass dampers on the clutch hub, e.g., as taught with respect to vehicle braking assemblies in U.S. Non-Provisional application Ser. No. 12/417,603 titled “Vehicle Braking Assembly.” It is also desirable to have a robust method of manufacturing a transmission clutch assembly to attach sprung mass and concentrated dampers to the clutch hub.

### SUMMARY

The present disclosure addresses one or more of the above-mentioned issues. Other features and/or advantages may become apparent from the description which follows.

One exemplary embodiment pertains to a method of manufacturing a transmission clutch assembly configured to reduce squawk during engagement, including: forming a clutch component; and coupling a plurality of mass dampers to the clutch component to split a mode of vibration for the clutch component during engagement.

Another exemplary embodiment pertains to a vehicle transmission gear clutch assembly made by a process of: forming a first receptor in a clutch component; and press-fitting a mass damper into the slot.

Another exemplary embodiment regards a vehicle transmission clutch assembly, having: a clutch component; a first receptor formed in the clutch component; and a tuned mass damper fitted into the receptor.

One advantage of the present disclosure is that it teaches methods of manufacture for clutch assemblies that reduce squawk and unwanted noise during clutch engagement. Some test samples showed a 10 decibel noise reduction.

Another advantage of the present disclosure is that it eliminates the need for additional fasteners or fastening material (e.g., such as what might be used in a screw attachment or welding process). The press-fit attachment methods disclosed herein enable sprung mass dampers to be rigidly attached to the clutch hub at one end and have the mass at the opposing end operate in a cantilevered fashion. This attachment method also dams opposing sides of the clutch hub when the damper is attached thereto.

The present disclosure is further advantageous in that it allows for the mass damper to be attached to a clutch hub at an inner or outer diameter, thereby producing a wide range of damping effects.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

The invention will be explained in greater detail below by way of example with reference to the figures, in which the same reference numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is a side cross-sectional view of a vehicle transmission having an exemplary clutch assembly disposed therein.

FIG. 2 is a perspective view of the clutch gear shown in FIG. 1.

FIG. 3 is a perspective view of one mass damper used with the clutch gear of FIG. 2.

FIG. 4 is a top view of the mass damper of FIG. 3.

FIG. 5 is a side view of a portion of the clutch gear of FIG. 2.

FIG. 6 is a side view of another exemplary mass damper.

FIG. 7 is a graph of displacement versus frequency for various clutch gears.

Although the following detailed description makes reference to illustrative embodiments, many alternatives, modifications, and variations thereof will be apparent to those skilled in the art. Accordingly, it is intended that the claimed subject matter be viewed broadly.

### DETAILED DESCRIPTION

Referring to the drawings, wherein like characters represent the same or corresponding parts throughout the several views there are shown various embodiments of a vehicle transmission with a clutch assembly having improved noise reduction capabilities. Significant noise reduction is accomplished by using a set of mass dampers in the clutch assembly. In one embodiment, for example, dampers are sprung mass dampers coupled to a clutch gear. Mass dampers change the mode of vibration for the clutch gear during engagement thus reducing noise output during gear shifting. Two sliding grooves (also referred to as receptors or slots) are positioned 180 degree apart on the clutch gear. The two dampers are press-fit into the grooves to attach the dampers to the clutch gear. This method of manufacture results in added lubrication benefits forming a lubrication dam between one side of the clutch gear and another side of the clutch gear when the mass damper is coupled thereto.

The uses of sprung mass dampers in some embodiments enable vibration control in multiple directions. The embodiments having sprung mass dampers have dual functionality—altering bending and torsion modes of vibration due to the outer rim effect. Exemplary clutch assemblies and methods of manufacture are discussed herein with reference to the figures.

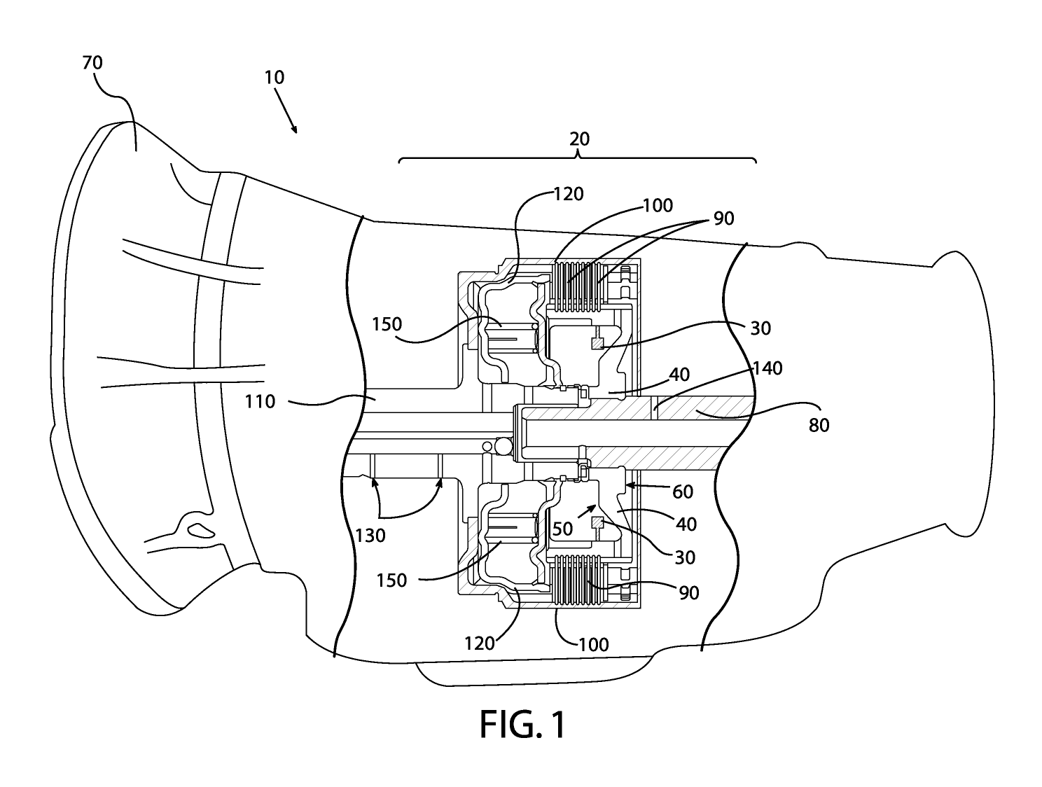

In FIG. 1, there is shown a vehicle transmission 10 compatible with the noise reduction teachings discussed hereinbelow. The transmission 10 is a six-speed automatic transmission in this embodiment. Other types of transmissions are compatible with the present disclosure; five-, seven- and eight speed transmissions can utilize the mass dampers taught herein. In other embodiments, the transmission is a manual transmission. Any type of transmission may be used including, for example, electrically variable transmissions or continuously variable transmissions.

As shown in FIG. 1, a transmission clutch assembly 20 includes two mass dampers 30 connected to an outer diameter of a clutch gear 40. The attachment method, as discussed hereinbelow, preserves a seal between an inner surface 50 of the clutch gear and an outer surface 60 of the clutch gear, which is exposed to other sections of the transmission. In this way the method of manufacture also yields increased stability for the transmission lubrication strategy.

The transmission bell housing 70 shown in FIG. 1 has a section partially cut away. In the center section of the transmission the clutch assembly 20 is positioned. The illustrated clutch assembly 20 includes the internal clutch gear 40 that is splined onto an output shaft 80. Clutch gear 40 sits on the inner diameter of a series of friction plates or clutches 90 that are journaled onto the clutch gear 40. On the outer diameter of clutches 90 a hub 100 encircles the clutches. Clutch hub 100 is attached to the transmission input shaft 110 (as partially shown in FIG. 1). Nested within the clutch hub 100 is also a piston 120. Piston 120 is hydraulically actuable. Input shaft 110 is configured with a series of orifices (e.g., 130) to control lubrication. Output shaft 80 also has a series of orifices (e.g., 140) to control lubrication. Piston 120 is hydraulically actuated in this embodiment; however, in other embodiments, piston can be electrically actuable (for example using e-shift and/or a servo motor to initiate clutch engagement). In this embodiment, piston 120 actuates the clutch assembly 20 from the front section of the transmission to the rear section of the transmission. A return spring 150 is incorporated in the clutch assembly 20 between a fore and aft wall of the piston 120.

Internally mounted in the clutch gear 40 are two sprung mass dampers 30 as shown in FIG. 1. Sprung mass dampers 30 are attached to inner surface 50 of clutch gear as described below.

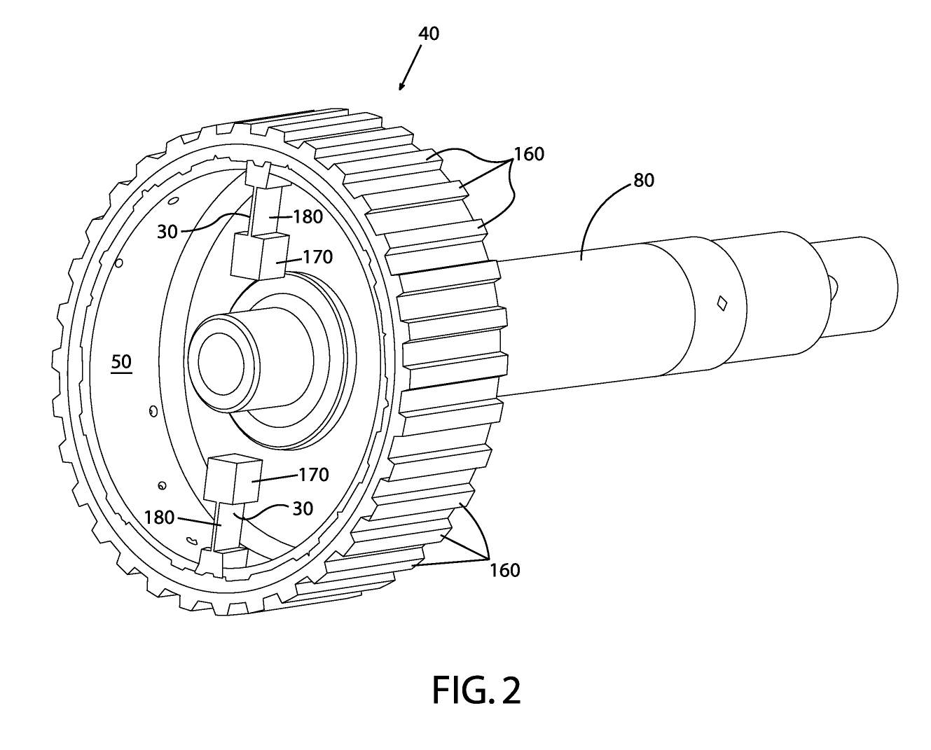

Now with reference to FIG. 2, there is shown the clutch gear 40 of FIG. 1 in isolation. FIG. 2 is a perspective view of the clutch gear 40. As shown, clutch gear 40 is attached to the output shaft 80. Clutch gear 40 includes a series of teeth 160 formed on the outer diameter of the clutch gear. Said teeth 160 are configured to engage with clutch plates (e.g., 90 as shown in FIG. 1). On the inner surface 50 or inner race of the clutch gear 40 are two sprung mass dampers 30. In this embodiment, sprung mass dampers 30 are shown to scale. In other embodiments, however sprung mass dampers 30 can be of different sizes and configurations. In this embodiment, clutch gear 40 is die cast using powder metallurgy. Clutch gear can be manufactured using any existing forming techniques including, for example, lathing, milling, stamping or welding.

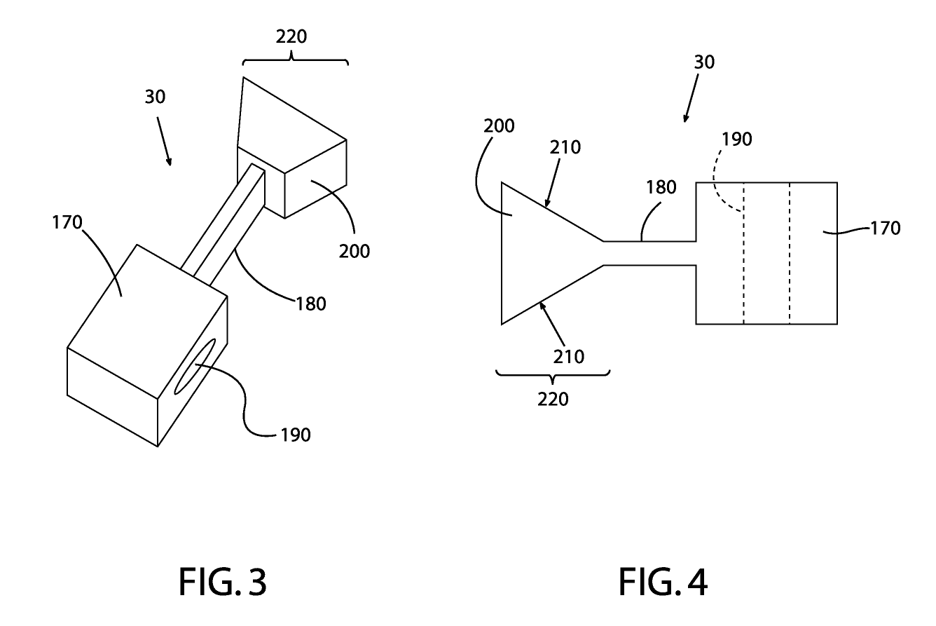

Sprung mass dampers 30 are press-fit into the inner surface 50 of clutch gear 40, as shown in FIG. 2. As shown in FIGS. 3 and 4, mass dampers 30 have a sprung mass 170 in a cantilevered orientation. The sprung mass 170 is free to vibrate with respect to the clutch gear 40 by the connector beam 180. FIG. 3 illustrates a perspective view of the sprung mass damper 30 used in the clutch gear 40 of FIG. 2.

As shown in FIGS. 3 and 4 mass damper 30 includes one sprung mass 170. Sprung mass 170 is located at one end of the damper 30. The mass 170 is configured in a rectangular shape in this embodiment. An orifice (or tuning hole) 190 is included in a center section of the mass 170 to control the weight of the mass. In this way, the same configuration for mass damper 170 can be implemented in different transmissions. Weight adjustments can be made to mass damper by enlarging or decreasing the size of orifice 190 in the mass 170.

At another end of the damper, as shown in FIGS. 3 and 4, an anchor 200 is included at the base of the damper 30. Anchor 200 is triangular shaped in this embodiment. Anchor 200 includes two angularly dispose prongs 210 at end 220 of the damper. Said prongs 210 are configured to fit in receptors formed in the clutch gear. Damper 30 is composed of steel. Damper 30 can also be composed of other materials, e.g., aluminum, stainless steel, polymers or a combination of any of the aforementioned materials. In this embodiment, damper 30 is formed using a powder metallurgy process. Orifice 190 is formed in damper 30 using a drilling process. Other forming techniques for mass damper will be appreciated by ordinary artisans as being within the scope of the present disclosure including, but not limited to, stamping, milling, molding, or extrusion.

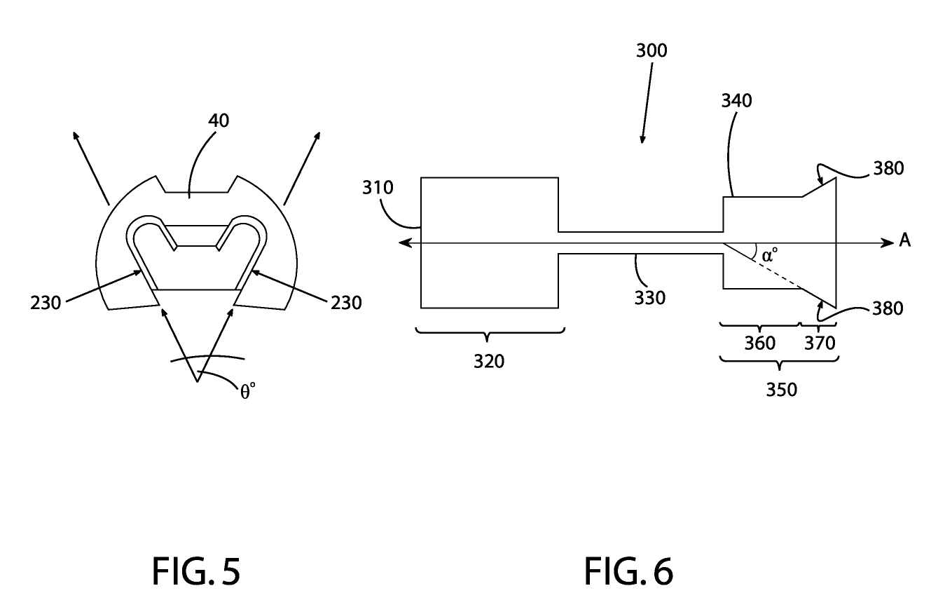

As shown in FIG. 5, two receptors 230 are formed in the clutch gear 40. Receptors 230 are configured to match the prongs 210 on mass damper 30. In this embodiment, receptors 230 are a U-shaped radial slot with angular disposition or fillet radius identified as theta, θ, in FIG. 5. In the embodiment of FIG. 5, theta is approximately 30 degrees. Accordingly, the arc degree of the receptors 230 formed in the clutch gear 40 is approximately 30 degrees. In other embodiments, the arc degree of the receptors is larger or smaller and then 30 degrees. As shown, prongs 210 and receptors 230 are configured to form a sealing connection between damper 30 and clutch gear 40. When damper 30 is inserted in receptors 230 the two form a lubrication dam or seal in the inner race 50 of clutch gear 40, e.g., as shown in FIG. 1.

Prongs 210 are fitted in the receptors 230 via a press-fit process. Any sort of pressing application can be used including (for example) stamping, hydroforming or a crimping process. Accordingly, a method of manufacturing a transmission clutch assembly configured to reduce squawk during engagement includes: forming a clutch component (e.g., the clutch gear 40 shown in FIG. 2); and press-fitting a plurality of mass dampers (e.g., 30 as shown in FIG. 2) into the clutch component to split a mode of vibration for the clutch component during engagement. As discussed, dampers can be formed using contemporary manufacturing techniques including milling, stamping, molding, lathing, injection molding or welding.

The press-fitting process can form a lubrication dam between the clutch component and the mass damper where the connection between the receptor and mass damper sufficiently form a fluid seal (e.g., as shown in FIG. 2).

Now referring to FIG. 6, there is shown therein an alternative environment of a sprung mass damper 300 for implementation into a transmission clutch gear. Mass damper 300 shown in FIG. 6 has a rectangular-shaped sprung mass 310 disposed at one end 320. In the middle section a narrow connector 330 is placed which acts as a cantilever between the mass 310 and an anchor 340. Anchor 340 is disposed at another end 350 of the damper. In this embodiment, anchor 340 has two sections. A first section 360 has a rectangular portion. The second section 370 has an angular disposition of alpha, a, with respect to a central axis, A, of the mass damper 300. In this embodiment alpha is approximately 45°. Anchor 340 forms two triangular prongs 380 at end 350 of damper 300. The prongs in anchor are also configured to join with compatible receptors formed in the clutch gear.

In this embodiment the dimensions of mass damper are 20 mm×30 mm. The connector is approximately 1.0 mm thick. In other embodiments, mass damper can change in size and configuration.

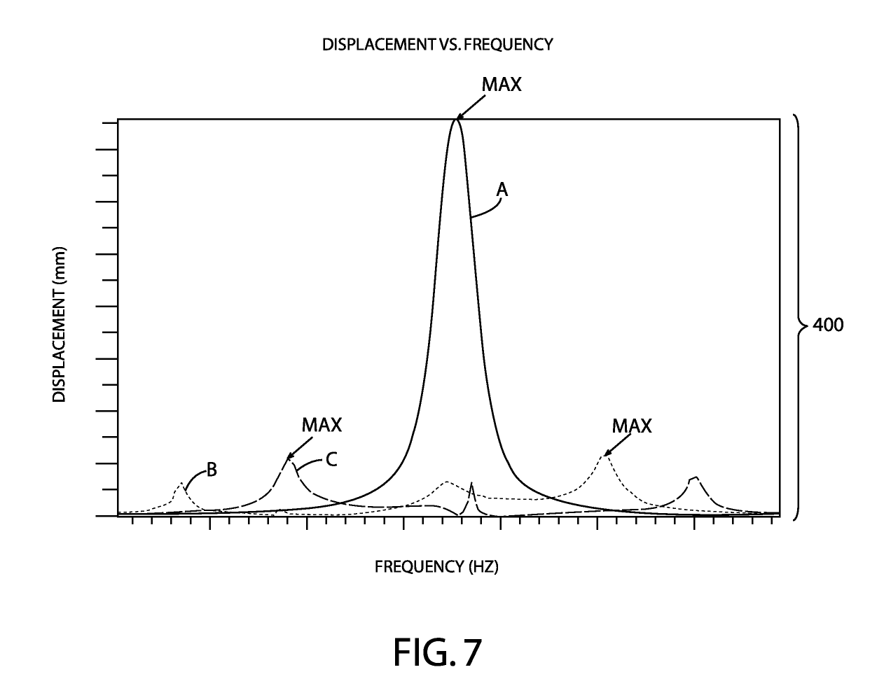

Now with reference to FIG. 7, there is shown therein some exemplary test results for different clutch gears expressed in graph 400. On the y-axis is displacement of the clutch during engagement. Displacement is measured in the form of millimeters. On the x-axis is frequency in Hertz. Line A represents data taken from a clutch gear not having any dampers incorporated therein. The maximum displacement of the rim hub represented by Line A is approximately 0.0007 mm and occurs at a frequency of 578 Hz. This baseline of 578 Hz is where the amplitude of the vibration curve is located for the clutch hub during engagement.

Lines B and C, as shown in FIG. 7, represent test data from clutch hubs having sprung mass dampers incorporated therein (e.g., as shown in FIGS. 2-3 and the above disclosure). The displacement of the clutch gear having sprung mass dampers attached thereto has a substantially smaller amplitude than the amplitude of the clutch gear without mass dampers. As shown in FIG. 7, the hubs associated with Lines B and C have a split mode of vibration. The double modes separate the maximum displacement of the clutch hub to avoid coupling with clutch resonance and avoid noise instability. The amplitude (or maximum) of the displacement versus frequency curve for Line B is approximately 0.0001 mm. This occurs at approximately 585 Hz. The amplitude of the displacement versus frequency curve for Line C is also approximately 0.0001 mm. This occurs at approximately 569 Hz.

As explained above the sprung mass dampers as discussed with respect to FIGS. 2 through 4 reduce unwanted vibration in at least two directions. Sprung mass dampers also reduce torque variation in the clutch assembly as demonstrated in the test results discussed hereinbelow. Referring now to Table 1, there is shown therein test data for a control clutch hub and a hub having the benefit of the present teachings. The torque variation was measured for each clutch hub at different pressure levels within the transmission. At a gross pressure of 0.86 MPa the clutch hub with dampers demonstrated a significantly lower torque variation than the clutch hub without dampers (90 Nm as compared to 290 Nm). A sample was taken at 0.99 MPa for each clutch hub. At this pressure the hub without dampers experienced 550 Nm of torque variation and the clutch with dampers experienced only 290 Nm in torque variation. Next measurements were taken at 1.13 MPa. The clutch hub without dampers experienced 850 Nm in torque variation while the clutch hub with dampers experienced 730 Nm of torque variation. Lastly, at the highest pressure tested (1.26 MPa) the clutch hub without dampers experienced 880 Nm of torque variation. The clutch hub with dampers only experienced 290 Nm of torque variation.

TABLE 1
Test Outcome for Clutch Hub with and without Dampers

| Test sample Type | Torque Variation | | | |
|---|---|---|---|---|
| Clutch hub without damper | 290 Nm | 550 Nm | 850 Nm | 880 Nm |
| Clutch hub with tuned mass | 90 Nm | 290 Nm | 730 Nm | 290 Nm |
| damper | | | | |

Those familiar with the art to which this invention relates will recognize various alternative designs and embodiments for practicing the invention within the scope of the appended claims. For example, different types of mass dampers can be affixed to clutch components including, but not limited to, concentrated mass dampers. Also, different transmission components can benefit from the damping and press-fit techniques disclosed herein (e.g., clutch pistons, other clutch hubs, etc.).

We claim:

1. A method of manufacturing a transmission clutch assembly configured to reduce squawk during engagement, comprising:
forming a clutch component; and
coupling a plurality of mass dampers to the clutch component to split a mode of vibration for the clutch component during engagement.

2. The method of claim 1, wherein coupling includes press-fitting the mass dampers to the clutch component.

3. The method of claim 1, further comprising:
forming a lubrication dam between the clutch component and the mass damper.

4. The method of claim 3, wherein forming the lubrication dam includes:
forming a receptor in the clutch component so that the mass damper can at least partially fit therein.

5. The method of claim 4, wherein the forming a receptor includes forming a slot in the clutch component.

6. A vehicle transmission gear clutch assembly made by a process of:
forming a first receptor in a clutch component; and
press-fitting a mass damper into the slot.

7. The clutch assembly of claim 6, further comprising:
forming a lubrication dam between the clutch component and the mass damper.

8. The clutch assembly of claim 6, wherein the first receptor is a radial slot.

9. The clutch assembly of claim 6, wherein the mass damper is a sprung mass damper.

10. The clutch assembly of claim 9, further comprising:
forming a second receptor in a clutch component; and
wherein the mass damper includes a plurality of prongs fittable in the first and second receptors.

11. The clutch assembly of claim 6, wherein the mass damper is configured to extend towards a center section of the clutch component.

12. The clutch assembly of claim 6, wherein the clutch component is a clutch gear.

13. A vehicle transmission clutch assembly, comprising:
a clutch component;
a first receptor formed in the clutch component; and
a tuned mass damper coupled to the receptor.

14. The clutch assembly of claim 13, wherein a fit between the damper and the receptor form a lubrication dam.

15. The clutch assembly of claim 13, wherein the receptor is a slot.

16. The clutch assembly of claim 15, wherein the slot is a radial slot.

17. The clutch assembly of claim 13, wherein the tuned mass damper is a sprung mass damper.

18. The clutch assembly of claim 17, wherein the tuned mass damper includes at least one prong fittable in the receptor.

19. The clutch assembly of claim 13, wherein the mass damper is configured to extend towards a center section of the clutch component.

20. The clutch assembly of claim 13, wherein the clutch component is a clutch gear.
